(19) United States
(12) Patent Application Publication
(10) Pub. No.: US 2008/0018630 A1
(43) Pub. Date: Jan. 24, 2008

(54) Liquid crystal display device, liquid crystal display and method of driving liquid crystal display device

(76) Inventor: Yusuke Fujino, Tokyo (JP)

Correspondence Address: WILLIAM S. FROMMER, Esq.;c/o FROMMER LAWRENCE & HAUG LLP, 745 Fifth Avenue, New York, NY, 10151, US

(21) Appl. No.: 11/879,336

(22) Filed: Jul. 17, 2007

(30) Foreign Application Priority Data
Jul. 18, 2006 (JP) P2006-195176

(51) Int. Cl. G09G 5/00; G09G 3/36

(52) U.S. Cl. 345/205; 345/87

(57) ABSTRACT

An image display device capable of displaying a high-quality image by reducing the occurrence of alignment disorder of a liquid crystal irrespective of details of the image is provided. A liquid crystal display device includes: a liquid crystal display panel including a plurality of pixels for displaying images; and a drive means for driving the liquid crystal display panel while correcting pixel data of each pixel one after another, so that a voltage ratio between a voltage applied to one pixel and a voltage applied to its neighboring pixel is reduced.

### CROSS REFERENCES TO RELATED APPLICATIONS

The present invention contains subject matter related to Japanese Patent Application JP 2006-195176 filed in the Japanese Patent Office on Jul. 18, 2006, the entire contents of which being incorporated herein by reference.

### BACKGROUND OF THE INVENTION

1. Field of the Invention

The present invention relates to an active matrix type liquid crystal display device, a liquid crystal display displaying an image through the use of the liquid crystal display device, and a method of driving the liquid crystal display device.

2. Description of the Related Art

In recent years, liquid crystal displays using a liquid crystal as a display device have been widely used. As the liquid crystal displays, for example, there have been commercialized various liquid crystal displays capable of providing a high-resolution image such as a so-called direct-view type liquid crystal display in which a liquid crystal drive circuit is formed on a large glass substrate, and which is combined with a light source such as a backlight, a polarizing plate, a color filter and the like, and a so-called projection type liquid crystal display in which pixels are formed on a very little substrate, and which is combined with an optical system to magnify and project an image. Moreover, as the drive modes of liquid crystals used in the liquid crystal displays, there are various modes such as a vertical alignment mode, a horizontal alignment mode, a ferroelectric liquid crystal mode and an OCB (Optically Compensated Bend) mode, and liquid crystal displays making full use of advantages of these modes have been developed.

In such liquid crystal displays, typically, a liquid crystal display device is driven by independently applying a voltage to each of pixels constituting a display region in a vertical direction of a substrate. However, in the case where a difference in drive voltage between a pixel and its neighboring pixel is large, a horizontal electric field is generated between the pixels, thereby the alignment of the liquid crystal may be disordered. The alignment disorder of the liquid crystal caused by a voltage difference between neighboring pixels is called disclination, and when such alignment disorder occurs, it is difficult to display a proper image based on pixel data of each pixel. In other words, for example, a decline in luminance or contrast, deformation of a fine image pattern or the like occurs, and, for example, in the case where colors are reproduced through the use of three primary colors, a change in the luminance of one of the primary colors may cause displaying wrong colors or the like.

Such an issue occurs in most of liquid crystal displays irrespective of the above-described types or drive modes of liquid crystals; however, the issue is more pronounced in the projection type liquid crystal display specifically due to its high magnification. In a projection type liquid crystal display in a related art, for example, a technique for reducing an influence of disclination by covering a part where disclination occurs with a black mask, and arranging a microlens array in an opening part to magnify and project an image is used; however, there are a number of demerits such as a decline in light use efficiency, so a further improvement is desired.

Therefore, for example, D. Cuypers et al, “Fringe-field inducted disclinations in VAN LCos panels”, IDW'04 Proceedings of The 11th International Display Workshops, Society for information Display, Dec. 8, 2004, LAD-3 discloses a reflective type microdisplay in which the alignment direction of a liquid crystal, alignment control and the occurrence of disclination are optimized by calculation. Moreover, Japanese Unexamined Patent Application Publication No. 2005-91527 discloses a technique of controlling the alignment of a plurality of liquid crystal display devices.

### SUMMARY OF THE INVENTION

However, in D. Cuypers et al, a method of achieving such a parameter is not specifically described, so it is difficult to actually achieve the parameter. On the other hand, in the technique in Japanese Unexamined Patent Application Publication No. 2005-91527, it is considered that a phenomenon in which wrong colors are displayed due to the occurrence of the above-described alignment disorder (disclination) of a liquid crystal can be reduced to some extent. However, the technique is not sufficient to reduce the phenomenon while dealing with ever-changing drive conditions of neighboring pixels.

In view of the foregoing, it is desirable to provide an image display device, an image display and a method of driving an image display device capable of reducing the occurrence of alignment disorder of a liquid crystal irrespective of the details of an image so as to display a high-quality image.

According to an embodiment of the invention, there is provided a liquid crystal display device including: a liquid crystal display panel including a plurality of pixels for displaying images; and a drive means for driving the liquid crystal display panel while correcting pixel data of each pixel one after another, so that a voltage ratio between a voltage applied to one pixel and a voltage applied to its neighboring pixel is reduced.

In this case, the drive means can correct the pixel data one after another on the basis of the time integration value of the reflectivity of a pixel over a plurality of predetermined frame periods as a determination index. In addition, “a plurality of frame periods” means a plurality of image frame periods or a plurality of image field periods.

According to an embodiment of the invention, there is provided a liquid crystal display including the above-described liquid crystal display device, and displaying an image through the use of light modulated by the liquid crystal display device. In this case, the liquid crystal display configured as a liquid crystal projector can includes a light source; and a projection means for projecting light to a screen, the light being emitted from the light source and modulated by the liquid crystal display device.

In the liquid crystal display device and the liquid crystal display according to the embodiment of the invention, pixel data of each pixel is corrected one after another so that a voltage ratio between a voltage applied to one pixel and a voltage applied to its neighboring pixel is reduced. Then, the liquid crystal display panel is driven on the basis of pixel data corrected.

According to an embodiment of the invention, there is provided a method of driving a liquid crystal display device including a liquid crystal display panel with a plurality of pixels for displaying images, the method including the steps of: comparing pixel data of one pixel and pixel data of its neighboring pixel; correcting pixel data one after another so that a voltage ratio between a voltage applied to the pixel and a voltage applied to the neighboring pixel is reduced, in the case where it is determined from a comparison result that the voltage ratio is larger than a predetermined threshold value; and driving the liquid crystal display panel on the basis of pixel data corrected.

In the method of driving a liquid crystal display device according to the embodiment of the invention, pixel data of one pixel and pixel data of its neighboring pixel are compared, and in the case where it is determined that the voltage ratio between a voltage applied to the pixel and a voltage applied to the neighboring pixel is larger than a predetermined threshold value, pixel data of each pixel is corrected one after another so that the voltage ratio is reduced. Then, the liquid crystal display pane is driven on the basis of pixel data corrected.

In the liquid crystal display device, the liquid crystal display and the method of driving a liquid crystal display device according to the embodiment of the invention, pixel data of each pixel is corrected one after another so that the voltage ratio between a voltage applied to one pixel and a voltage applied to its neighboring pixel is reduced, and t the liquid crystal panel is driven on the basis of pixel data corrected, so the occurrence of the alignment disorder (disclination) of the liquid crystal due to the voltage ratio between the voltages applied to neighboring pixels can be reduced, and a deterioration in image reproducibility can be prevented. Therefore, irrespective of the details of an image, a high-quality image can be displayed.

Other and further objects, features and advantages of the invention will appear more fully from the following description.

### BRIEF DESCRIPTION OF THE DRAWINGS

FIG. 1 is an illustration showing the configuration of a liquid crystal display device according to a first embodiment of the invention;

FIG. 2 is a sectional view showing the configuration of a liquid crystal display section shown in FIG. 1;

FIGS. 3A and 3B are sectional views for describing alignment disorder occurring in a liquid crystal display device in a related art;

FIGS. 4A and 4B are sectional views following FIGS. 3A and 3B for describing the alignment disorder;

FIG. 5 is a functional block diagram showing a detailed configuration of an image signal correction section shown in FIG. 1;

FIGS. 6A and 6B are illustrations for describing a correction table;

FIGS. 7A and 7B are illustrations for describing an image signal correction function according to the first embodiment;

FIG. 8 is an illustration for describing an image signal correction function according to a modification of the first embodiment;

FIG. 9 is an illustration for describing an image signal correction function according to a modification of the first embodiment;

FIG. 10 is a configuration diagram showing an example of a liquid crystal display formed through the use of the liquid crystal display device shown in FIG. 1;

FIG. 11 is a timing chart for describing a method of driving a digital type liquid crystal display device;

FIG. 12 is an illustration for describing an image signal correction function according to a second embodiment;

FIG. 13 is an illustration for describing an image signal correction function according to a modification of the second embodiment;

FIG. 14 is an illustration for describing an image signal correction function according to a modification of the second embodiment;

FIGS. 15A and 15B are illustrations showing pixel patterns of a liquid crystal display device used in examples and comparative examples;

FIG. 16 is a plot showing a relationship between transmittance, reflection efficiency of a pixel and contrast in a liquid crystal display device according to a comparative example;

FIGS. 17A and 17B are illustrations for describing an image signal correction function according to a modification of the invention;

FIGS. 18A and 18B are plots for comparing and describing reflection efficiencies in Comparative Example 3 and Example 3; and

FIG. 19 is a configuration diagram showing another example of the liquid crystal display formed through the use of a liquid crystal display device according to the invention.

### DETAILED DESCRIPTION OF THE PREFERRED EMBODIMENTS

Preferred embodiments will be described in detail below referring to the accompanying drawings.

### First Embodiment

### <Configuration of Liquid Crystal Display Device>

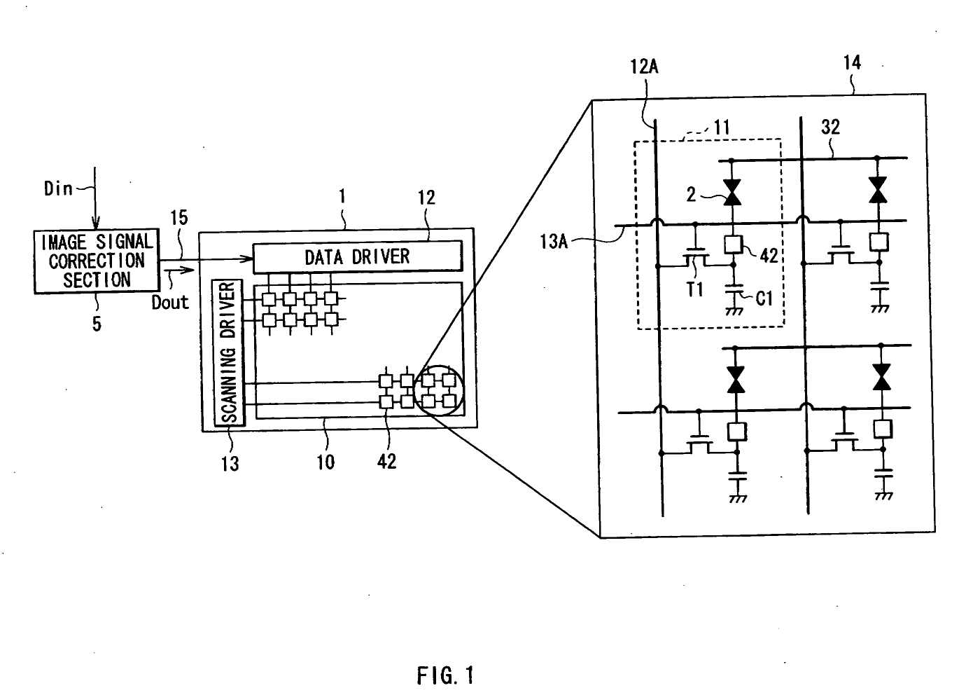

FIG. 1 shows the configuration of a liquid crystal display device according to a first embodiment of the invention. The liquid crystal display device includes an image signal correction section 5 performing predetermined correction on an input image signal Din from outside and a liquid crystal display section 1 displaying an image on the basis of an image signal (an output image signal Dout) corrected by the image signal correction section 5, and the liquid crystal display device is a reflective type liquid crystal display device as will be described later.

The liquid crystal display section 1 includes a display region 10 in which a plurality of pixels 11 are arranged in a matrix form, and a data driver 12 and a scanning driver 13 as drivers for image display.

A pixel drive circuit 14 is formed in each pixel 11, and the above-described data driver 12 and the above-described scanning driver 13 are arranged around the display region 10. The output image signal Dout from the image signal correction section 5 is inputted into the data driver 12 via a signal line 15. The pixel drive circuit 14 is formed below each reflective pixel electrode 42 which will be described later, and typically includes a switching transistor T1 and an auxiliary capacity C1 supplying a voltage to a liquid crystal 2.

In the pixel drive circuit 14, a plurality of data lines 12A are arranged in a column direction, and a plurality of scanning lines 13A are arranged in a row direction. The intersection of each data line 12A and each scanning line 13A corresponds to 1 pixel. A source electrode of each transistor T1 is connected to the data line 12A, and a gate electrode is connected to the scanning line 13A. A drain electrode of each transistor T1 is connected to each reflective pixel electrode 42 and the auxiliary capacity C1. Each data line 12A is connected to the data driver 12, and an image signal is supplied from the data driver 12. Each scanning line 13A is connected to the scanning driver 13, and a scanning signal is supplied from the scanning driver 13 in order.

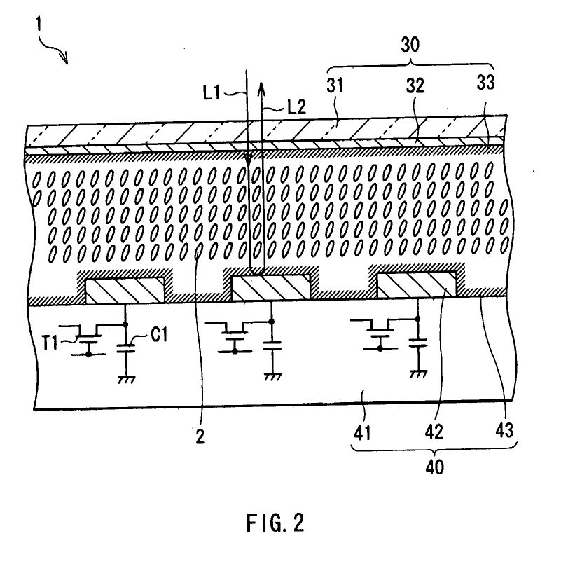

FIG. 2 shows a sectional view of the liquid crystal display section 1. The liquid crystal display section 1 includes a pair of an opposed substrate 30 and a pixel electrode substrate 40 facing each other, and the vertically-aligned liquid crystal 2 injected between these substrates 30 and 40.

The opposed substrate 30 includes a glass substrate 31 and a transparent electrode 32 laminated on the glass substrate 31. An alignment film 33 is laminated on the whole surface contacting the vertically-aligned liquid crystal 2 of the transparent electrode 32. The transparent electrode 32 is made of an electrode material having a light transmission property, typically ITO (Indium Tin Oxide; an indium tin oxide film) which is a solid solution material of tin oxide (SnO₂) and indium oxide (In₂O₃). A common potential (for example, a ground potential) is applied to the transparent electrode 32 in the whole pixel region.

The pixel electrode substrate 40 is formed, for example, by forming the reflective pixel electrodes 42 in a matrix form on a single-crystal silicon substrate 41. An active type drive circuit including the transistor T1 and a capacitor (auxiliary capacity) C1 such as a CMOS (Complementary Metal-Oxide Semiconductor) or an NMOS (negative Metal-Oxide Semiconductor) is formed on the silicon substrate 41. Further, an alignment film 43 is laminated on the whole surface contacting the vertically-aligned liquid crystal 2 of the pixel electrode substrate 40.

The reflective pixel electrode 42 is made of a metal film typified by aluminum (Al) or silver (Ag). In the case where an aluminum electrode or the like is used as the reflective pixel electrode 42, the reflective pixel electrode 42 has both a function as a light reflective film and a function as an electrode applying a voltage to a liquid crystal. To increase reflectivity, a reflective layer made of a multilayer film such as a dielectric mirror may be formed on the aluminum electrode.

In the vertically-aligned liquid crystal 2 used in the reflective type liquid crystal display device, when no voltage is applied, the molecular long axis is aligned in a substantially vertical direction with respect to each substrate surface, and when a voltage is applied, the molecular long axis is tilted in an in-plane direction, thereby the polarization state is changed. When the direction where liquid crystal molecules are tilted is not uniform during driving, the contrast becomes uneven, so to prevent this, it is necessary to vertically align the liquid crystal molecules by aligning the liquid crystal molecules at a very small pretilt angle in a uniform direction (typically a direction diagonal to a device) in advance. When the pretilt angle is too large, the vertical alignment of the liquid crystal molecules is deteriorated, thereby the black level increases, and the contrast decreases, so the pretilt angle is controlled within 1° to 7°.

As the alignment films 33 and 43, for example, an obliquely evaporated film of silicon oxide typified by silicon dioxide (SiO₂) is used. In this case, the pretilt angle of the above-described vertically-aligned liquid crystal 2 is controlled by changing an evaporation angle during oblique evaporation. As the alignment films 33 and 43, for example, films formed by performing a rubbing (alignment) process on a polyimide-based organic compound can be also used. In this case, the pretilt angle can be controlled by changing the conditions of rubbing.

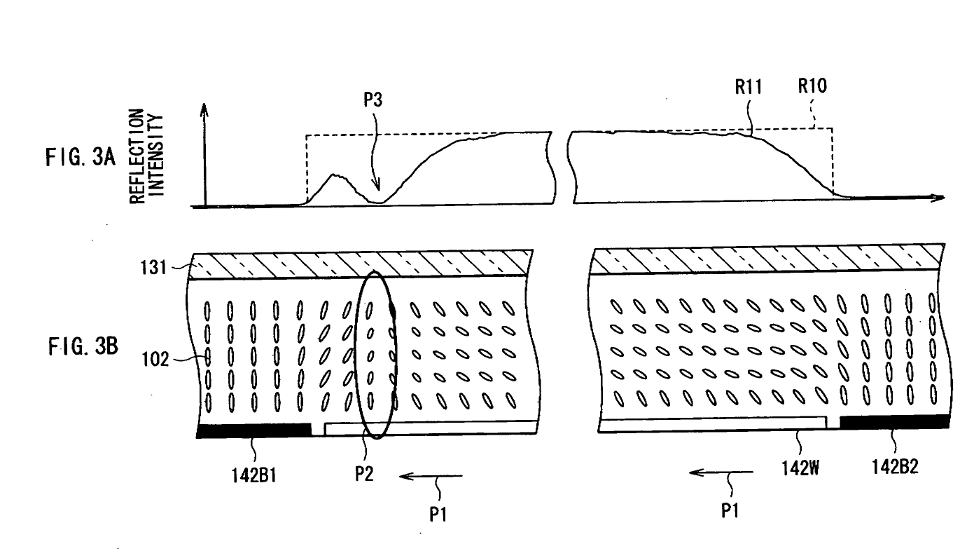

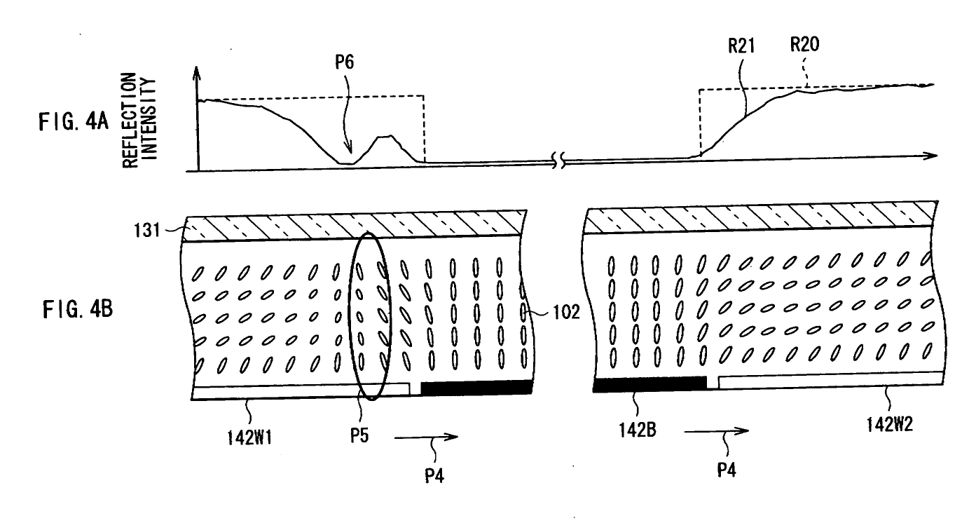

In this case, referring to FIGS. 3A, 3B, 4A and 4B, alignment disorder (disclination) occurring in a liquid crystal display device in a related art will be described below. FIGS. 3A, 3B, 4A and 4B show the mode of the occurrence of alignment disorder, and FIGS. 3A and 4A show a relationship between positions in a liquid crystal display section and light reflection intensity, and FIGS. 3B and 4B show a relationship between positions in the liquid crystal display section and the alignment direction of a vertically-aligned liquid crystal 102. Reference numerals R10 and R20 in the drawings indicate ideal reflection intensity characteristics and reference numerals R11 and R21 indicate actual reflection intensity characteristics. Moreover, reference numerals P1 and P4 in the drawings indicate the pretilt direction of the vertically-aligned liquid crystal 102 (a direction where vertically-aligned liquid crystal molecules are tilted at the time of applying a voltage to each pixel, and is determined by the pretilt direction), and reference numerals 142W, 142W1 and 142W2 schematically indicate pixels to which a white level voltage is applied, that is, pixels having higher luminance than a first predetermined level (white-display pixels), and reference numerals 142B, 142B1 and 142B2 schematically indicate pixels to which a black level voltage is applied, that is, pixels having lower luminance than a second predetermined level which is lower than the first predetermined level (black-display pixels).

It is obvious from FIGS. 3B and 4B that a voltage difference between an applied white level voltage and the applied black level voltage is extremely large around the boundary between the white-display pixel 142W and the black-display pixel 142B1 and around the boundary between the white-display pixel 142W1 and the black-display pixel 142B, so a horizontal electric field is generated between the pixels, and as shown by reference numerals P2 and P5, the alignment of the liquid crystal 102 is disordered. In other words, in the white-display pixels 142W1 and 142W, the liquid crystal 102 is supposed to be aligned in a horizontal direction; however, the liquid crystal 102 is aligned in a vertical direction due to the horizontal electric field generated between the pixels. Therefore, as shown by reference numerals P3 and P6 in the drawings, due to such alignment disorder of the liquid crystal 102, the light reflection intensity in this part locally declines, and a black bar appears on the liquid crystal display section. Moreover, for example, a decline in luminance or contrast, deformation of a fine image pattern or the like occurs, and, for example, in the case where colors are reproduced through the use of three primary colors, a change in the luminance of one of the primary colors may cause displaying wrong colors or the like.

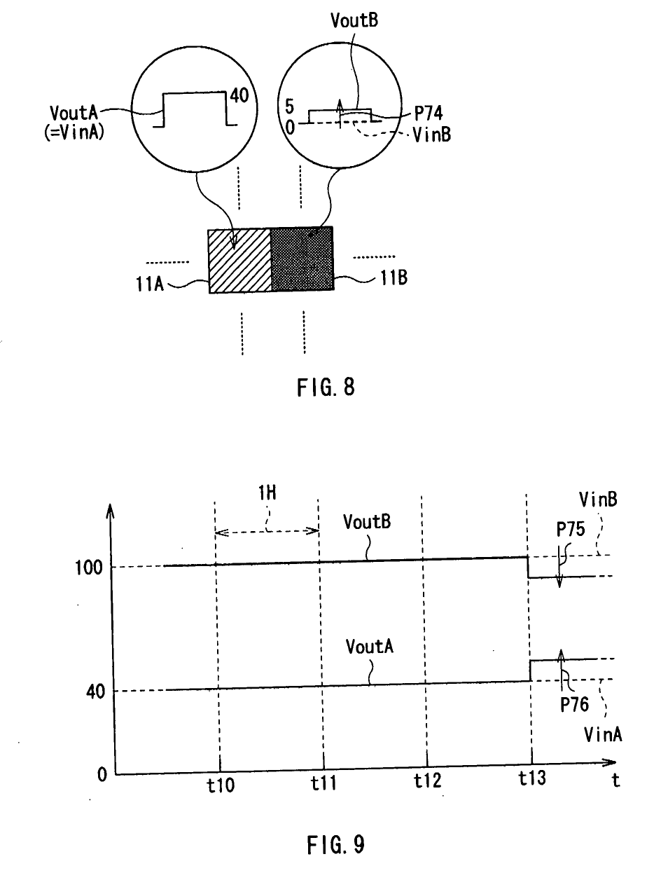

Moreover, it is obvious from FIGS. 3B and 4B that such alignment disorder occurs in the position of the white-display pixel of a couple of neighboring pixels arranged so that a transition of pixel display state from white to black takes place along the pretilt direction P1 or P4 of the vertically-aligned liquid crystal 102. Therefore, to efficiently correct image signals one after another by the image signal correction section 5 which will be described later, it is desirable to selectively (preferentially) perform correction on such neighboring pixels. The detail will be described later (refer to FIG. 8).

Referring back to FIG. 1, the image signal correction section 5 performs predetermined correction on the input image signal Din from outside.

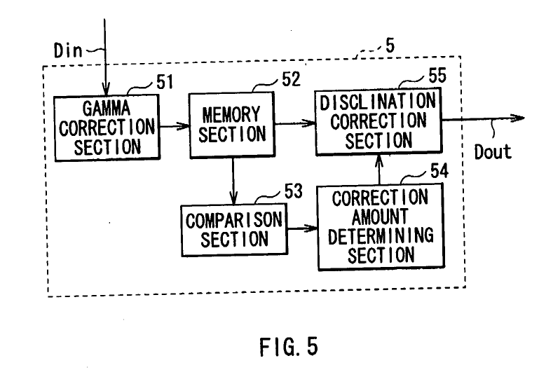

FIG. 5 shows a functional block diagram of the image signal correction section 5. The image signal correction section 5 includes a gamma correction section 51, a memory section 52, a comparison section 53, a correction amount determining section 54 and a disclination correction section 55.

The gamma correction section 51 performs predetermined gamma correction on the input image signal Din from outside. The gamma correction is correction performed on each pixel on the basis of a so-called V-T curve (a drive voltage-light output curve) depending on the thickness of a liquid crystal layer, an output light wavelength or the like in each device.

The memory section 52 is a section storing necessary image signals (pixel data) of pixels among image signals of pixels on which gamma correction is performed by the gamma correction section 51, that is, necessary pixel data for comparison with pixel data of a neighboring pixel as will be described below, and includes, for example, an SRAM (Static Random Access Memory) or the like.

The comparison section 53 compares the pixel data of each pixel with the pixel data of its neighboring pixel with reference to the pixel data stored in the memory section 52. More specifically, the comparison section 53 compares a potential difference between an applied voltage (drive voltage) to one pixel and a voltage applied to its neighboring pixel.

The correction amount determining section 54 determines whether a voltage ratio between a voltage applied to one pixel and a voltage applied to its neighboring pixel is larger than a predetermined threshold value on the basis of a comparison result by the comparison section 53, and in the case where the correction amount determining section 54 determines that the voltage ratio is larger than the predetermined threshold value, the correction amount determining section 54 determines the correction amount of the pixel data of each pixel through the use of a predetermined correction table so as to reduce the voltage ratio.

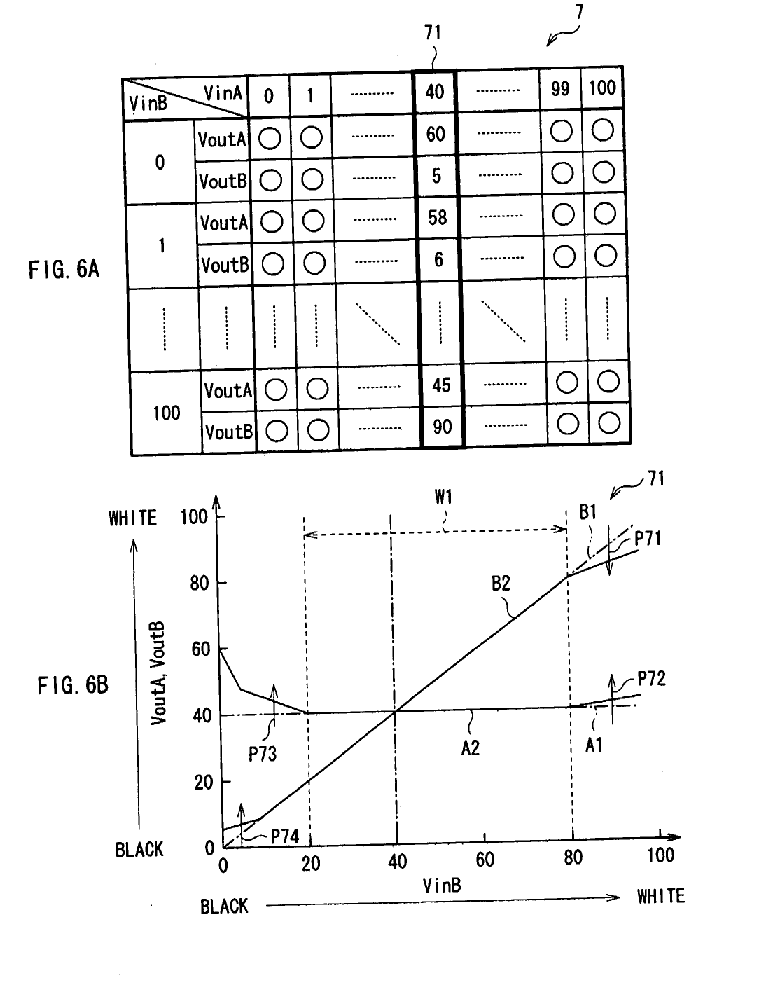

FIGS. 6A and 6B show an example of a correction table 7 providing a correction amount in neighboring pixels 11A and 11B as an example of the correction table, and FIG. 6A shows a relationship between the values of pixel data VinA and VinB of the pixels 11A and 11B on which correction is not yet performed and the values of the pixel data VoutA and VoutB of the pixels 11A and 11B on which correction has been performed. Moreover, FIG. 6B shows a correction table 71 providing a relationship between VinB, VoutA and VoutB in the case of VinA=40 in the correction table 7. In the drawings, “0” to “100” as the values of VinA, VinB, VoutA and VoutB indicate the magnitudes of the voltages applied (drive voltages) to the pixels 11A and 11B, and indicate percentages in the case where a black-display level is “0”, and a white level is “100”. Moreover, reference numerals A1 and B1 in FIG. 6B indicate characteristics of VinA and VinB, respectively, and reference numerals A2 and B2 indicate the characteristics of VoutA and VoutB, respectively.

According to the correction tables 7 and 71 in FIGS. 6A and 6B, for example, in the case where it is found out from the comparison result by the comparison section 53 that the pixel data VinA of the pixel 11A is VinA=40, and the pixel data VinB of the pixel 11B is VinB=0, the correction amount determining section 54 determines the correction amounts of the pixel data VinA and VinB so that the corrected pixel data VoutA of the pixel 11A becomes VoutA=60 and the corrected pixel data VoutB of the pixel 11B becomes VoutB=5.

Moreover, a data range W1 shown in FIG. 6B provides a threshold value at the time of determining whether or not to correct pixel data one after another. In other words, in the correction table 71, as an example, in the case where the ratio between a larger value of pixel data between the pixels 11A and 11B and a smaller value of pixel data is two or more times larger, more specifically in the case of VinB=20 or less or VinB=80 or more with respect to VinA=40 (out of the data range W1), pixel data is corrected one after another.

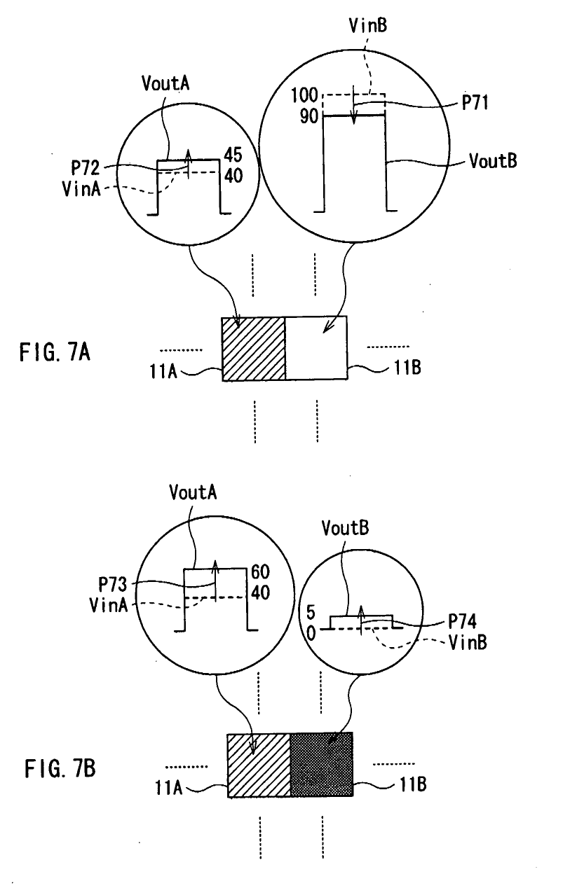

More specifically, for example, as shown in FIG. 7A, in the case of VinA=40 and VinB=100, the correction amount determining section 54 determines the correction amounts of the pixel data VinA and VinB according to the correction table 71 one after another so that the pixel data VoutA becomes VoutA=45 and the pixel data VoutB becomes VoutB=90 as shown by arrows P72 and P71 in FIGS. 6B and 7A. In other words, the correction amounts are determined so that the ratio of pixel data is reduced from VinB/VinA=100/40 to VoutB/VoutA=90/45.

Moreover, for example, as shown in FIG. 7B, in the case of VinA=40 and VinB=0, the correction amount determining section 54 determines the correction amounts of the pixel data VinA and VinB according to the correction table 71 one after another so that the pixel data VoutA becomes VoutA=60 and the pixel data VoutB becomes VoutB=5 as shown by arrows P73 and P74 in FIGS. 6B and 7B. In other words, the correction amounts are determined so that the ratio of pixel data is reduced from VinA/VinB=40/0 to VoutB/VoutA=60/5. Further, in the case where one of pixel data is in a black level (or around the black level), it is preferable that the value of the pixel data in the black level is preferentially increased, that is, a voltage applied to black-display pixels becomes higher. In such a case, even if the value of the pixel data is not much changed, the effect of reducing the ratio of the pixel data is increased (in this case, the ratio is reduced from infinity (∞) to 15).

For example, as shown in FIG. 8, in the case of VinA=40 and VinB=0, the correction amount determining section 54 may determine the correction amounts of the pixel data VinA and VinB one after another so that the pixel data VoutA becomes VoutA=40 and the pixel data VoutB becomes VoutB=5. It is more preferable that a couple of neighboring pixels arranged such that a transition of pixel display state from white to black takes place along the above-described pretilt direction are selectively (preferentially) corrected in such a manner, because the ratio of the pixel data is further reduced from VinA/VinB=40/0 to VoutB/VoutA=40/5.

Thus, the correction amounts of the pixel data are determined one after another by the correction amount determining section 54 through the use of the correction table 7, and the correction amounts are outputted to the disclination correction section 55.

Referring back to FIG. 5, the disclination correction section 55 generates output image data Dout as a corrected image signal by adding the correction amount determined by the correction amount determining section 54 to the pixel data stored in the memory section 52, and outputs the output image data Dout to the data driver 12 in the liquid crystal display section 1.

Next, the functions of the liquid crystal display device according to the embodiment will be described below.

In the reflective type liquid crystal display device, as shown in FIG. 2, incident light L1 entering from the opposed substrate 30 side and passing through the vertically-aligned liquid crystal 2 is reflected by the reflection function of the reflective pixel electrode 42. The light L1 reflected by the reflective pixel electrode 42 passes through the vertically-aligned liquid crystal 2 and the opposed substrate 30 in a direction opposite to the incident direction, then the light L1 is outputted. At this time, the optical properties of the vertically-aligned liquid crystal 2 are changed depending on a potential difference between facing electrodes, thereby the light L1 passing through the vertically-aligned liquid crystal 2 is modulated. Gray levels can be displayed by the light modulation, and modulated light L2 is used to display an image.

A voltage is applied to the vertically-aligned liquid crystal 2 by the pixel drive circuit 14 shown in FIG. 1. The data driver 12 supplies an image signal to the data line 12 on the basis of the output image signal Dout inputted from the image signal correction section 5 via the signal line 15. The scanning driver 13 supplies a scanning signal in order to each scanning line 13A at predetermined time intervals. Thereby, scanning is performed by the scanning signal from the scanning line 13A, and a pixel to which the image signal from the data line 12A is applied is selectively driven.

In this case, in the image signal correction section 5 shown in FIG. 5, on the basis of the input image data Din from outside, the pixel data of each pixel 11 in the display region 10 is corrected one after another so that the voltage ratio between an applied voltage (drive voltage) to one pixel and a voltage applied to its neighboring pixel is reduced. More specifically, the pixel data on which gamma correction has been performed by the gamma correction section 51 is stored in the memory section 52, and the pixel data of one pixel and the pixel data of its neighboring pixel in the stored pixel data are compared by the comparison section 53. Then, on the basis of the comparison result, in the case where the correction amount determining section 54 determines that the voltage ratio between the voltage applied to the pixel and the voltage applied to its neighboring pixel is larger than the predetermined threshold value through the use of the correction tables 7 and 71 shown in FIGS. 6A and 6B, for example, as shown in FIGS. 6A and 6B to FIG. 8, the pixel data of each pixel is corrected one after another so that the voltage ratio is reduced, and the display gray level or the gray level ratio of each pixel approaches a desired value. Then, on the basis of the pixel data corrected (the output image signal Dout), the above-described display drive operation is performed in the liquid crystal display section 1.

As described above, in the liquid crystal display device according to the embodiment, in the image signal correction section 5, the pixel data (the input image signal Din) of each pixel 11 is corrected one after another so that the voltage ratio between a voltage applied to one pixel and a voltage applied to its neighboring pixel is reduced, and on the basis of the pixel data corrected (the output image signal Dout), the display drive operation is performed in the liquid crystal display section 1, so the occurrence of alignment disorder (disclination) of the liquid crystal due to a difference between voltages applied to neighboring pixels can be reduced, and a deterioration in image quality producibility can be prevented. Therefore, irrespective of the details of the image (the value of the input image signal Din), a high-quality image can be displayed.

Moreover, the correction amount determining section 54 in the image signal correction section 5 determines the correction amount through the use of, for example, a predetermined correction table as shown in FIGS. 6A and 6B, so the correction amount provided in advance is simply selected; therefore, correction can be performed easily at high speed.

Further, when one of the pixel data is in the black level (or around black level), in the case where the value of the pixel data in the black level is preferentially increased, that is, a voltage applied to the black-display pixels becomes higher, even if the value of the pixel data is not much changed, the ratio of the pixel drive voltage can be effectively reduced. Therefore, the alignment disorder of the liquid crystal can be reduced more easily.

In addition, in the case where a couple of neighboring pixels arranged such that a transition of pixel display state from white to black takes place along the pretilt direction of the vertically-aligned liquid crystal 2 are selectively (preferentially) corrected, correction is performed on a part where the alignment disorder of the liquid crystal easily occurs; therefore, the image signal can be more efficiently corrected one after another. Further, correction is performed by setting correction priorities, so the failure of the correction process can be prevented. In addition, in the case where the pretilt direction of the vertically-aligned liquid crystal 2 is, for example, a direction diagonal to pixels (a direction at 45 degrees from a horizontal direction or a vertical direction in the case where pixels have a square shape), the couple of neighboring pixels arranged such that a transition of pixel display state from white to black takes place along a direction of a horizontal or vertical component of a vector representing the pretilt direction of liquid crystal molecules are selectively (preferentially) corrected. More specifically, the comparison section 53 is able to detect whether each pixel is a black-display pixel or a white-display pixel. Then, in the case where an alignment film is formed on a pixel electrode so that liquid crystal molecules are tilted from bottom right to top left with respect to pixels, when the comparison section 53 detects a state in which a black-display pixel is arranged on the left side and a white-display pixel is arranged on the right side in the couple of neighboring pixels, the correction amount determining section 54 selectively (preferentially) corrects the pixels.

For example, as shown in a timing chart in FIG. 9, the pixel data may be corrected one after another, for example, as shown by arrows P75 and P76 in the drawing on the basis of the time integration value of reflectivity of each pixel over a plurality of predetermined frame periods (or three horizontal periods (one horizontal period=1H) from timings t10 to t13 in a plurality of field periods) as a determination index. In such a configuration, in the case where the pixel signal is not changed throughout a plurality of frame periods, a deterioration in image quality producibility due to the occurrence of disclination can be effectively prevented.

### <Configuration of Liquid Crystal Display>

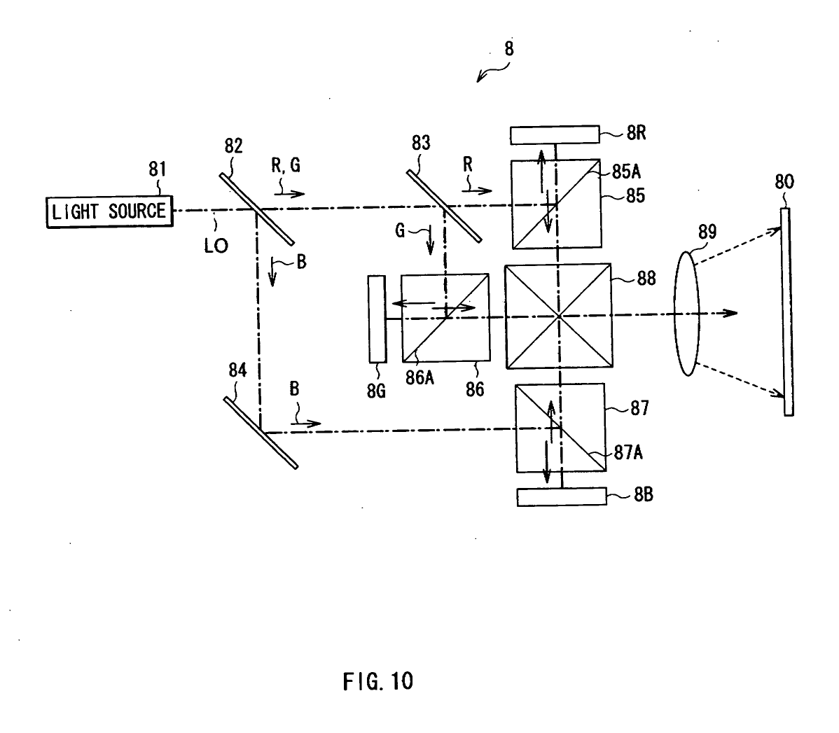

Next, an example of a liquid crystal display using the liquid crystal display device with the configuration shown in FIG. 1 will be described below. As shown in FIG. 10, an example of a reflective type liquid crystal projector (a liquid crystal projector 8) using the reflective type liquid crystal display device as a light valve will be described below.

The liquid crystal projector 8 is a so-called three-panel system projector displaying a color image through the use of three liquid crystal light valves 8R, 8G and 8B for red, green and blue, respectively. The reflective type liquid crystal projector 8 includes a light source 81, dichroic mirrors 82 and 83, and a total reflection mirror 84 along an optical axis LO. The liquid crystal projector 8 also includes polarizing beam splitters 85, 86 and 87, a synthesizing prism 88, a projection lens 89 and a screen 80.

The light source 81 emits white light including red light (R), blue light (B) and green light (G) which are necessary to display a color image, and includes, for example, a halogen lamp, a metal halide lamp, a xenon lamp or the like.

The dichroic mirror 82 has a function of separating light from the light source 81 into blue light and light of other colors. The dichroic mirror 83 has a function of separating light passing through the dichroic mirror 82 into red light and green light. The total reflection mirror 84 reflects blue light separated by the dichroic mirror 82 toward the polarizing beam splitter 87.

The polarizing beam splitters 85, 86 and 87 are arranged along the optical paths of red light, green light and blue light, respectively. The polarizing beam splitters 85, 86 and 87 have polarization splitting surfaces 85A, 86A and 87A, respectively, and the polarizing beam splitters 85, 86 and 87 each have a function of separating each incident color light into two polarization components perpendicular to each other in the polarization splitting surfaces 85A, 86A and 87A. The polarization splitting surfaces 85A, 86A and 87A reflect one of the polarization components (for example, an S-polarization component), and pass the other polarization component (for example, a P-polarization component) therethrough.

The liquid crystal light valves 8R, 8G and 8B each include the reflective type liquid crystal display device with the above-described configuration (refer to FIGS. 1 and 2). Color light of predetermined polarization components (for example, the S-polarization component) separated by the polarization splitting surfaces 85A, 86A and 87A of the polarizing beam splitters 85, 86 and 87 enter the liquid crystal light valves 8R, 8G and 8B, respectively. The liquid crystal light valves 8R, 8G and 8B are driven according to a drive voltage applied on the basis of the image signal, and the liquid crystal light valves 8R, 8G and 8B have a function of modulating incident light and reflecting the modulated light toward the polarizing beam splitters 85, 86 and 87, respectively.

The synthesizing prism 88 has a function of synthesizing color light of predetermined polarization components (for example, the P-polarization component) emitted from the liquid crystal light valves 8R, 8G and 8B and passing through the polarizing beam splitters 85, 86 and 87. The projection lens 89 has a function as a projection means for projecting synthesized light emitted from the synthesizing prism 88 toward the screen 80.

In the reflective type liquid crystal projector 8 configured as described above, at first, white light emitted from the light source 81 is separated into blue light and light of other colors (red light and green light) by the function of the dichroic mirror 82. The blue light is reflected toward the polarizing beam splitter 87 by the function of the total reflection mirror 84. On the other hand, the light of other colors is separated into red light and green light by the function of the dichroic mirror 83. The separated red light and the separated green light enter the polarizing beam splitters 85 and 86, respectively.

The polarizing beam splitters 85, 86 and 87 each separate each incident color light into two polarization components perpendicular to each other in the polarization splitting surfaces 85A, 86A and 87A, respectively. At this time, the polarization splitting surfaces 85A, 86A and 87A reflect one of the polarization components (for example, the S-polarization component) toward the liquid crystal light valves 8R, 8G and 8B, respectively.

The liquid crystal light valves 8R, 8G and 8B are driven according to a drive voltage applied on the basis of the image signal, and modulate color light of predetermined incident polarization components on a pixel-by-pixel basis. At this time, the liquid crystal light valves 8R, 8G and 8B each include the reflective type liquid crystal display device shown in FIGS. 1 and 2, so superior characteristics such as contrast or image quality can be achieved.

The liquid crystal light valves 8R, 8G and 8B reflect each modulated color light toward the polarizing beam splitters 85, 86 and 87, reflectively. The polarizing beam splitters 85, 86 and 87 pass only predetermined polarization components (for example, the P-polarization components) of reflected light (modulated light) from the liquid crystal light valves 8R, 8G and 8B therethrough, respectively, and emit the polarization components toward the synthesizing prism 88. The synthesizing prism 88 synthesizes color light of the predetermined polarization components passing through the polarizing beam splitters 85, 86 and 87, and emits the synthesized light toward the projection lens 89. The projection lens 89 projects the synthesized light emitted from the synthesizing prism 88 toward the screen 80. Thereby, an image according to light modulated by the liquid crystal light valves 8R, 8G and 8B is projected on the screen 80, and a desired image is displayed.

As described above, in the liquid crystal projector according to the embodiment, the reflective type liquid crystal display devices shown in FIGS. 1 and 2 are used as the liquid crystal light valves 8R, 8G and 8B, so the occurrence of alignment disorder (disclination) of the liquid crystal due to a difference between in voltages applied to neighboring pixels is reduced, and a deterioration in image quality producibility can be prevented. Therefore, an image can be displayed with high quality and high producibility.

### Second Embodiment

Next, a second embodiment of the invention will be described below. In the first embodiment, a so-called analog system liquid crystal display device in which an applied voltage (a drive voltage) is changed on the basis of pixel data is described. On the other hand, in the embodiment, a so-called digital system liquid crystal display device in which a drive by PWM (Pulse Width Modulation) is performed on the basis of pixel data will be described below.

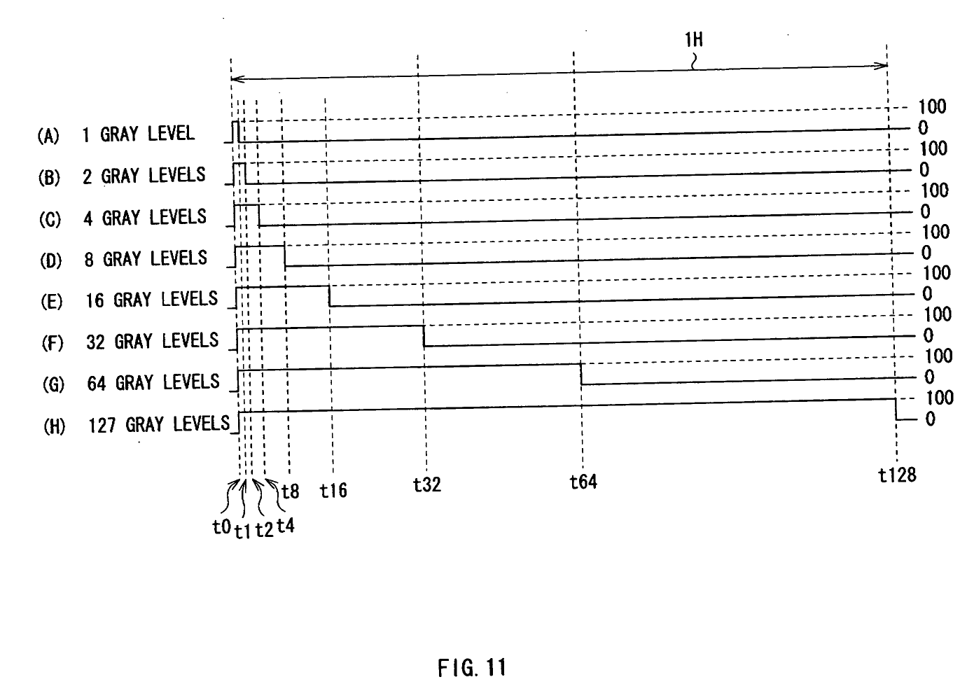

FIG. 11 shows a timing chart of a method of driving a typical digital system (in this case, 128 (=2 to the seventh power) gray-level/7-bit drive system) liquid crystal display device, and (A) through (H) show 1 gray level (=pixel data of “0000001”; a black level), 2 gray levels (=pixel data of “0000010”), 4 gray levels (=pixel data of “0000100”), 8 gray levels (=pixel data of “0001000”), 16 gray levels (=pixel data of “0010000”), 32 gray levels (=pixel data of “0100000”), 64 gray level (=pixel data of “1000000”) and 127 gray levels (=pixel data of “1111111”; white level), respectively.

In the method of driving the digital system liquid crystal display device, the width of the period in which a voltage is applied to each pixel 11 is changed by assigning weights to each bit of pixel data so as to display gray levels. Moreover, the time of 1 field is divided into 128 regions, and a V100 voltage or a V0 voltage is applied during the combinations of 1st to 64th regions, 64th to 96th regions, 96th to 112th regions, 112th to 120th regions, 120th to 124th regions, 124th to 126th regions, and 126th to 127th regions. Therefore, in the liquid crystal display device according to the embodiment, the case where a voltage ratio between neighboring pixels is large corresponds to a voltage ratio between an applied voltage corresponding to “0 (L; low)” level and an applied voltage corresponding to “1 (H; high)” level.

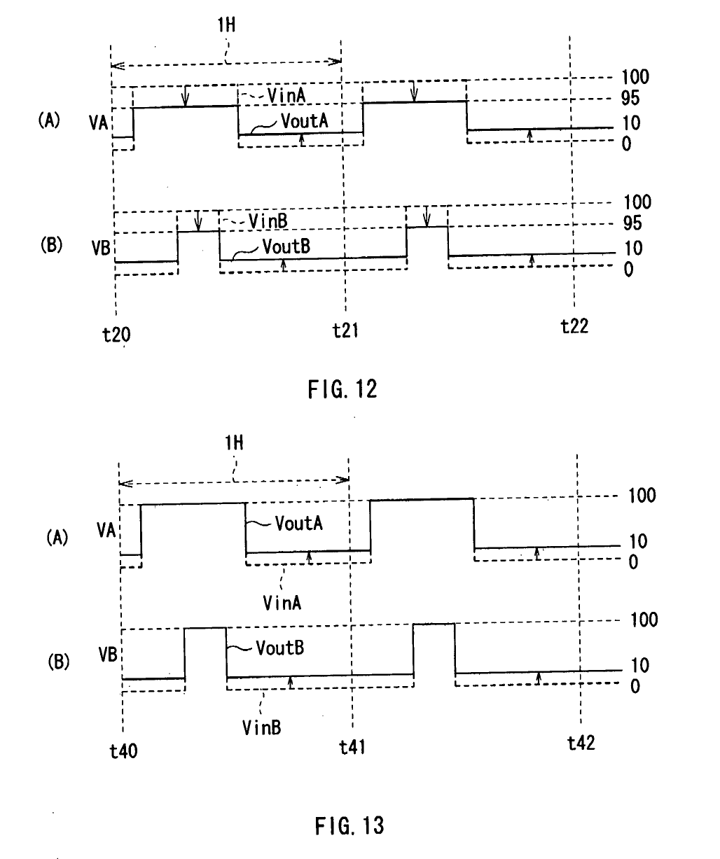

Therefore, in the embodiment, for example, as shown in a timing chart of FIG. 12, an applied voltage corresponding to “0 (L; low)” level is increased (in this case, the applied voltage is changed from “0” to “10”), and an applied voltage corresponding to “1 (H; high)” level is decreased (in this case, the applied voltage is changed from “100” to “95”).

Moreover, for example, as shown in a timing chart of FIG. 13, only the applied voltage corresponding to the “0 (L; low)” level may be changed (to be higher). It is because in such a case, as in the case of the first embodiment, even if the designated value is not much changed, a voltage ratio can be easily reduced.

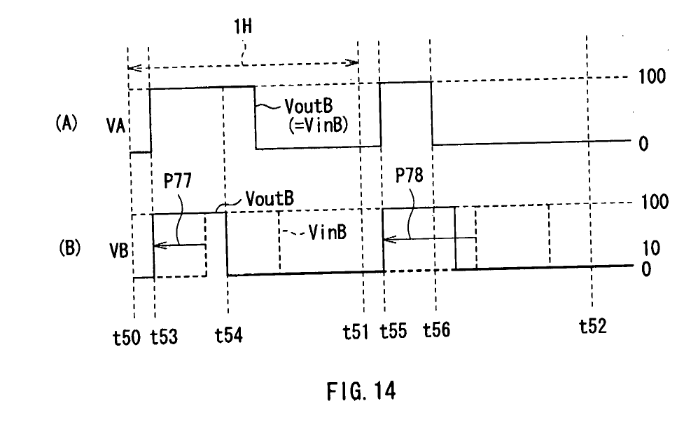

Further, for example, as shown in a timing chart of FIG. 14, a voltage application period may be shifted to a time axis direction so that the voltage application periods of neighboring pixels 11A and 11B overlap each other for a longer time. It is because in the method of driving a digital system liquid crystal display device in a related art as shown in FIG. 11, for example, the time of one field is divided into 128 regions, and a V100 voltage or V0 voltage is applied during the combinations of 1st to 64th regions, 64th to 96th regions, 96th to 112th regions, 112th to 120th regions, 120th to 124th regions, 124th to 126th regions and 126th to 127th regions, so the voltage application periods of neighboring pixels often fail to overlap each other. As a detailed description of FIG. 14, as shown by arrows P77 and P78 in the drawing, the voltage application period of the pixel 11B is shifted in each horizontal period so as to overlap the voltage application period of the pixel 11A for as a long time as possible (the voltage application period is shifted in a time axis direction so as to coincide with a period from timings t53 to t54 and a period from timings t55 to t56). In such a configuration, without changing the applied voltage corresponding to “0 (L; low)” level or the applied voltage corresponding to “1 (H; high)” level, a period in which the voltage ratio between neighboring pixels is large can be minimized.

As described above, also in the liquid crystal display device according to the embodiment, in the image signal correction section 5, the pixel data is corrected one after another so that the voltage ratio between a voltage applied to one pixel and a voltage applied to its neighboring pixel is reduced, so the same effects as those in the first embodiment can be obtained. In other words, the occurrence of alignment disorder (disclination) of the liquid crystal due to a difference between voltages applied to neighboring pixels can be reduced, and a deterioration in image quality producibility can be prevented. Therefore, irrespective of details of an image, an image can be displayed with high image quality.

In addition, as in the case of the first embodiment, the liquid crystal display device according to the embodiment can be also applied to a liquid crystal display such as a liquid crystal projector, and the same effects as those in the first embodiment can be obtained.

### EXAMPLES

Next, specific characteristics of the liquid crystal display device according to the above-described embodiment will be described with examples. Before describing the examples, characteristics of a liquid crystal display device in a related art will be described with a comparative example.

### Comparative Example 1

A test sample of a reflective type liquid crystal display device as a comparative example was formed by the following steps. At first, after a glass substrate on which a film of a transparent electrode was formed and a silicon substrate were washed, they were put into an evaporation apparatus, and a SiO₂ film as an alignment film was formed by oblique evaporation at an evaporation angle of 50° to 55°. The thickness of the alignment film was 25 to 100 nm, and the alignment of a liquid crystal was controlled so that the pretilt angle of the liquid crystal was approximately 3°. After that, an appropriate number of glass beads with a diameter of approximately 2 μm were sprayed between the above-described substrates on which the alignment film was formed so that the substrates were bonded together, and a vertically aligned liquid crystal material with negative dielectric anisotropy Δ∈ and refractive index anisotropy Δn=0.11 manufactured by Merck was injected between the substrates so as to form the reflective type liquid crystal display device including a liquid crystal layer with a thickness of approximately 2 μm. On the above-described silicon substrate, pixel electrodes capable of independently controlling a drive voltage were constructed, and the pixel electrodes each had a square shape with a side of 6 μm, and pixels were separated by a 0.3 μm-wide groove, and an aluminum reflective film was formed on the surfaces of the pixel electrodes.

After forming the liquid crystal display device, a voltage corresponding to an AC square wave of approximately 60 Hz was applied to each pixel, and then a relationship of reflectivity to amplitude voltage was obtained. Moreover, a voltage V100 indicating the maximum reflectivity was determined, and the transmittance at that time was T100. Further, the transmittance at which the reflectivity was x % with respect to T100 was Tx, and the voltage at that time was a voltage Vx.

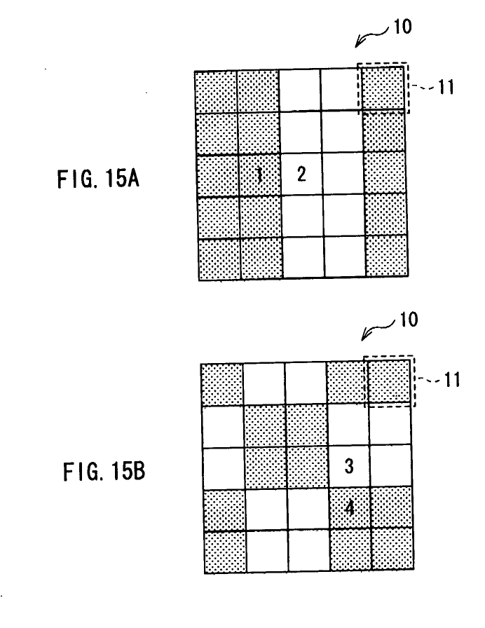

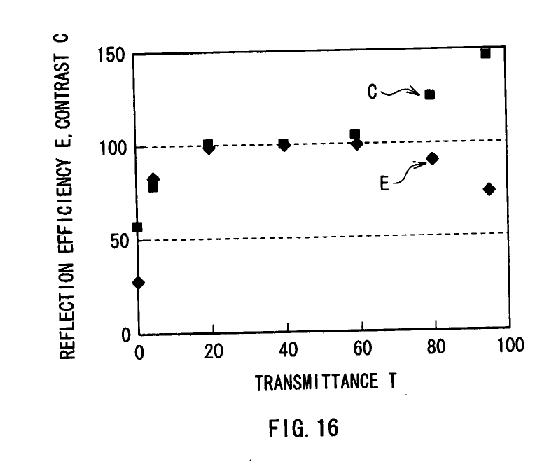

Images of various pixel patterns as shown in FIGS. 15A and 15B (a black-white pattern with alternating two black columns and two white columns and a checkered pattern with black and white squares of 2×2 pixels) were displayed through the use of the reflective type liquid crystal display device, and the reflectivity in neighboring pixels 1 and 2 and neighboring pixels 3 and 4 was measured. Moreover, the reflection efficiency E (=an average value of the ratio of actual integration reflectivity to reflectivity expected in each pixel) of each of the neighboring pixels, and the contrast C (=the ratio of the ratio of actual integration reflectivity to the ratio of reflectivity expected in each pixel) between one pixel and its neighboring pixel were determined as first and second indexes. The relationship between the transmittance T, the reflection efficiency E and the contract C determined in such a manner (in the case where a voltage before correcting one of neighboring pixels was V40) is shown in FIG. 16. It was confirmed that as the voltage ratio between neighboring pixels was increased (in this case, as the transmittance T was departed from T40), the values of the reflection efficiency E and the contract C were departed from 100, and an error from the expected value became larger.

### Examples 1-1, 1-2

Test samples of the reflective type liquid crystal display device were formed basically by the same method and the same specifications as those in Comparative Example 1. However, in Examples 1-1 and 1-2, unlike Comparative Example 1, as described in FIGS. 6A and 6B through FIG. 8 or FIG. 9 in the first embodiment, while correction was performed so that the voltage ratio between neighboring pixels was reduced as small as possible, images of pixel patterns shown in FIGS. 15A and 15B were displayed.

Table 1 shows an example of measurement results of the reflection efficiency E and the contrast C in Comparative Example 1 and Examples 1-1 and 1-2 (in the case where a voltage before correcting one of neighboring pixels was V40). In this case, it was considered that when the reflection efficiency E was 0.70 or more, and the contrast C was 0.60 or more, a displayed image could have sufficient quality for practical use. It was confirmed that while the reflection efficiency E and the contrast C were below the values in part in Comparative Example 1, in Examples 1-1 and 1-2, they exceeded the values. Therefore, it was found out that in Examples 1-1 and 1-2, the voltage ratio between neighboring pixels was smaller than that in Comparative Example 1, and display quality was improved. Moreover, it was found out that compared to Example 1-2, the values in Example 1-1 was slightly higher, and the display quality was further improved.

TABLE 1

| | | VOLTAGE RATIO (PIXEL 1/PIXEL 2) | | | | | | VOLTAGE RATIO (PIXEL 3/PIXEL 4) | | | | | |
|---|---|---|---|---|---|---|---|---|---|---|---|---|---|
| | | V5/95 | V20/90 | V45/50 | V50/45 | V90/20 | V95/5 | V5/95 | V20/90 | V45/50 | V50/45 | V90/20 | V95/5 |
| COMPARATIVE | E | 0.58 | 0.70 | 0.98 | 1.00 | 0.95 | 0.93 | 0.56 | 0.70 | 0.98 | 1.00 | 0.91 | 0.93 |
| EXAMPLE 1 | C | 0.53 | 0.71 | 1.00 | 1.01 | 1.08 | 1.10 | 0.48 | 0.63 | 1.00 | 0.98 | 1.12 | 1.20 |
| EXAMPLE 1-1 | E | 0.85 | 0.88 | 1.00 | 1.00 | 0.97 | 0.98 | 0.92 | 0.94 | 0.98 | 1.00 | 0.91 | 0.93 |
| | C | 0.70 | 0.70 | 1.00 | 1.00 | 1.05 | 1.05 | 0.82 | 0.84 | 1.00 | 0.98 | 1.12 | 1.20 |
| EXAMPLE 1-2 | E | 0.85 | 0.85 | 0.98 | 1.00 | 0.96 | 0.93 | 0.80 | 0.82 | 0.98 | 1.00 | 0.91 | 0.93 |
| | C | 0.68 | 0.73 | 1.00 | 1.01 | 1.08 | 1.10 | 0.70 | 0.72 | 1.00 | 0.98 | 1.12 | 1.20 |

### Comparative Example 2

A test sample of the reflective type liquid crystal display device was formed basically by the same method and the same specifications as those in Comparative Example 1. However, in Comparative Example 2, unlike Comparative Example 1, by a method of driving a typical digital system liquid crystal display device described in FIG. 11, that is, a method of driving a 7-bit digital system liquid crystal display device in which the time of one field was divided into 128 regions, and a V100 voltage or a V0 voltage was applied during the combinations of 1st to 64th regions, 64th to 96th regions, 96th to 112th regions, 112th to 120th regions, 120th to 124th regions, 124th to 126th regions and 126th to 127th regions, images of pixel patterns shown in FIGS. 15A and 15B were displayed.

### Examples 2-1, 2-2

Test samples of the reflective type liquid crystal display device were formed basically by the same method and the same specifications as those in Comparative Example 1. However, in Examples 2-1 and 2-2, unlike Comparative Example 2, while correction described in FIG. 12 or FIG. 14 in the second embodiment was performed, images of the pixel patterns shown in FIGS. 15A and 15B were displayed.

Table 2 shows an example of measurement results of reflection efficiency E and the contrast C in Comparative Example 2 and Examples 2-1 and 2-2 (in the case where gray levels before correcting one of neighboring pixels was (40/128) gray levels). As in the case of Table 1, it was confirmed that while the reflection efficiency E and the contrast C were below the values in part in Comparative Example 2, in Examples 2-1 and 2-2, they exceeded the values. Therefore, it was found out that in Examples 2-1 and 2-2, the voltage ratio between neighboring pixels was smaller than that in Comparative Example 2, and the display quality was improved. Moreover, it was found out that compared to Example 2-1, the values of the reflection efficiency E and the contrast C in Example 2-2 was slightly higher, and the display quality was further improved.

TABLE 2

| | | VOLTAGE RATIO (PIXEL 1/PIXEL 2) | | | | | | VOLTAGE RATIO (PIXEL 3/PIXEL 4) | | | | | |
|---|---|---|---|---|---|---|---|---|---|---|---|---|---|
| | | V5/95 | V20/90 | V45/50 | V50/45 | V90/20 | V95/5 | V5/95 | V20/90 | V45/50 | V50/45 | V90/20 | V95/5 |
| COMPARATIVE | E | 0.43 | 0.59 | 0.72 | 0.72 | 0.96 | 0.93 | 0.28 | 0.47 | 0.62 | 0.63 | 0.93 | 0.89 |
| EXAMPLE 2 | C | 0.42 | 0.51 | 0.40 | 0.47 | 0.81 | 0.48 | 0.26 | 0.37 | 0.25 | 0.30 | 0.77 | 0.33 |
| EXAMPLE 2-1 | E | 0.74 | 0.79 | 0.87 | 0.87 | 0.97 | 0.94 | 0.71 | 0.75 | 0.81 | 0.81 | 095 | 0.91 |
| | C | 0.70 | 0.77 | 0.66 | 0.78 | 0.90 | 0.75 | 0.71 | 0.70 | 0.65 | 0.71 | 0.90 | 0.70 |
| EXAMPLE 2-2 | E | 0.75 | 0.84 | 0.99 | 1.00 | 0.98 | 0.94 | 0.76 | 0.80 | 0.99 | 0.99 | 0.94 | 0.93 |
| | C | 0.73 | 0.82 | 0.98 | 0.98 | 0.93 | 0.77 | 0.73 | 0.75 | 0.98 | 0.98 | 0.92 | 0.72 |

### Comparative Example 3

A test sample of the reflective type liquid crystal display device was formed basically by the same method and the same specifications as those in Comparative Example 1. However, in Comparative Example 3, a voltage difference between neighboring pixels (as a pixel A and a pixel B) having different pixel drive voltages (=(voltage VB of the pixel B-voltage VA of the pixel A)) was considered as a determination index, and correction was performed so that the voltage difference was reduced.

### Example 3

A test sample of the reflective type liquid crystal display device was formed basically by the same method and the same specifications as those in Comparative Example 1. Moreover, in Example 3, as in the case of Examples 1-1, 1-2, 2-1 and 2-2, a voltage ratio between the pixel A and the pixel B (=(VB/VA)) was considered as a determination index, and correction was performed so that the voltage ratio was reduced.

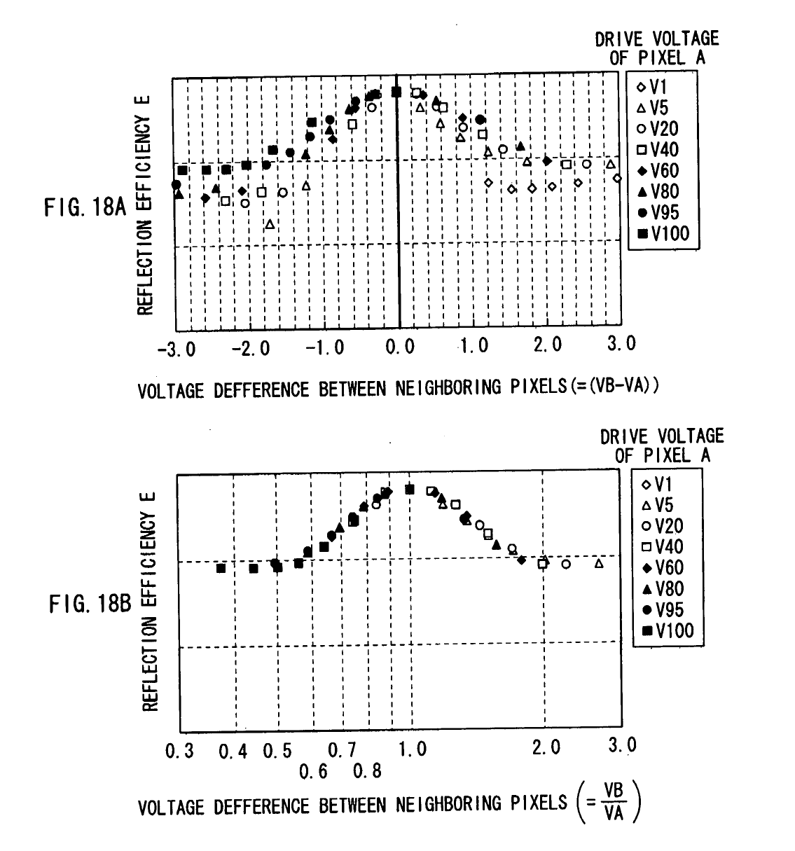

FIG. 18A shows an example of a correlation between a voltage difference between neighboring pixels and the reflection efficiency E (in the case where VA was changed to V1, V5, V20, V40, V60, V80, V95 and V100) on the basis of the measurement result on Comparative Example 3. FIG. 18B shows an example of a correlation between a voltage ratio between neighboring pixels and the reflection efficiency E (in the case where VA was changed to V1, V5, V20, V40, V60, V80, V95 and V100) on the basis of the measurement result on Example 3.

It was obvious from FIGS. 18A and 18B that a decline in the reflection efficiency E due to disclination caused by different pixel drive voltages of neighboring pixels was clearly more dependent on the voltage ratio in Example 3 than the voltage difference in Comparative Example 3. Therefore, it was found out that when the threshold value or the priority in the case where correction was performed was designated, in the case where a pixel subjected to correction was selected (determined) on the basis of the voltage ratio, compared to the case where the pixel was selected on the basis of the voltage difference between neighboring pixels, more efficient correction could be performed. Moreover, it was found out that regarding the correction amount, in the case where correction was performed so that the value of the voltage ratio was reduced, compared to the case where correction was performed so that voltage difference between the neighboring pixels was reduced, more effective correction could be performed.

Although the present invention is described referring to the first and the second embodiments and the examples, the invention is not limited to them, and can be variously modified.

For example, in the above-described embodiments and the like, the case where the liquid crystal in the liquid crystal display section 1 is the vertically-aligned liquid crystal 2 is described; however, the invention can be applied to various liquid crystal modes such as horizontally aligned liquid crystal, ferroelectric liquid crystal, TN (Twisted Nematic) mode liquid crystal, OCB mode liquid crystal in addition to the above case.

Moreover, in the above-described embodiments and the like, the reflective type liquid crystal display device and the reflective type liquid crystal display are described; however, the invention can be applied to, for example, transmissive type and semi-transmissive type liquid crystal display devices and transmissive type and semi-transmissive type liquid crystal displays in addition the them. However, in the case of the reflective type, as shown in FIG. 2, the pixel drive circuit 14 is formed below the pixel electrodes 42, so the pixel pitch and the pixel space tend to be narrower than those in the transmissive type, so specifically in the reflective type, alignment disorder (disclination) easily occurs. Therefore, when the invention is applied to specifically the reflective type, the effects are large.

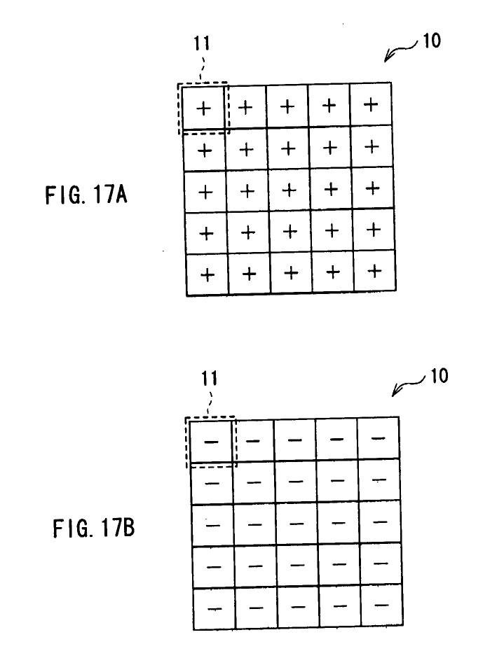

Moreover, in the invention, for example, as shown in FIGS. 17A and 17B, it is desirable that the liquid crystal display device is driven in a mode of frame inversion drive or field inversion drive in which the direction where the pixel drive voltage is applied is inverted between a positive direction (the application direction in each pixel 11 is schematically shown as “+”) and a negative direction (in FIG. 17B, the application direction in each pixel 11 is schematically shown as “−”) in each frame or each field. In such drive, the occurrence of the alignment disorder (disclination) is reduced.

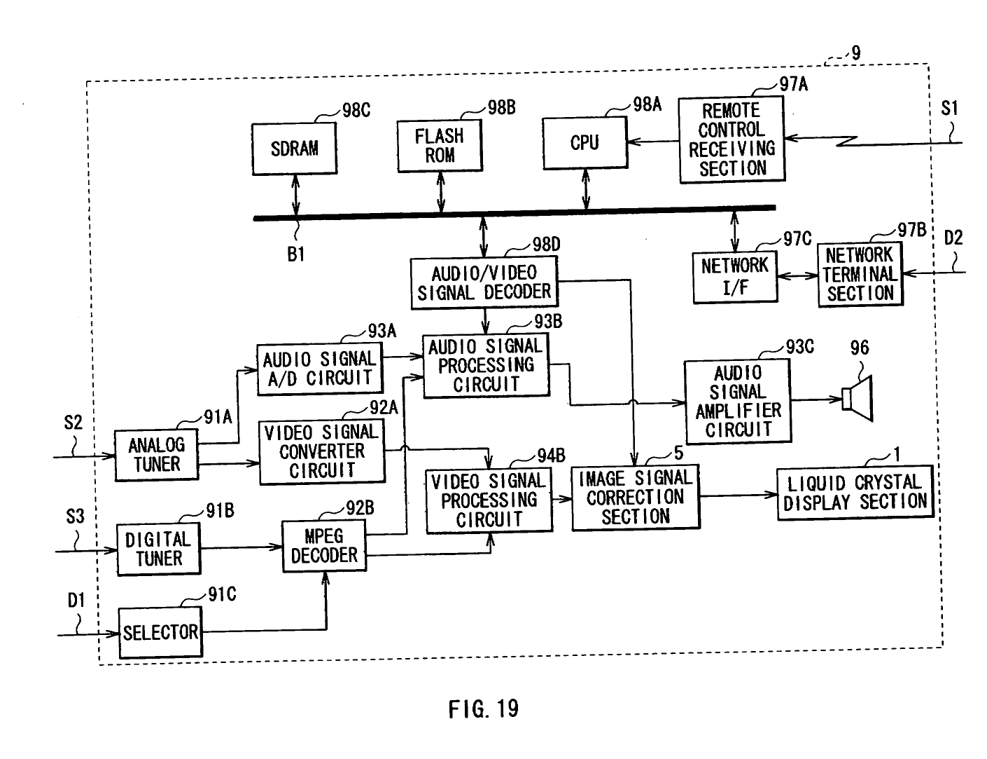

In the above-described embodiments and the like, as an example of the liquid crystal display using the liquid crystal display device according to the embodiments of the invention, the reflective type liquid crystal projector (the liquid crystal projector 8) using the liquid crystal display device is described; however, the liquid crystal display device according to the embodiments of the invention can be applied to a TV (TeleVision), a PDA (Personal Digital Assistants), a cellular phone and the like. FIG. 19 shows an example of a circuit configuration in the case where the liquid crystal display device (the liquid crystal display section 1 and the image signal correction section 5) described in the embodiments is applied to a TV. For example, a TV 9 includes: an analog tuner 91A receiving and demodulating an analog broadcast wave signal and outputting an image signal and an audio signal as baseband signals; a digital tuner 91B receiving and demodulating a digital broadcast wave signal, and outputting it as an MPEG-TS stream signal; a selector 91C inputting outside input data D1 (an MPEG-TS stream signal or the like); an MPEG (Moving Picture Experts Group) decoder 92B demodulating the MPEG-TS stream signal outputted from the digital tuner 91B or the selector 91C and outputting it as a digital component signal; a video signal converter circuit 92A demodulating a video baseband signal, and performing A/D (Digital/Analog) conversion on the video baseband signal, and outputting it as a digital component signal; an audio signal A/D (Analog/Digital) circuit 93A performing A/D conversion on the audio baseband signal outputted from the analog tuner 91A, and outputting it as a digital audio signal; an audio signal processing circuit 93B performing a predetermined audio signal process such as, for example, level adjustment, synthesis, or stereo processing on the digital audio signal outputted from the audio signal A/D circuit 93A or an audio/video signal decoder 98D which will be described later; an audio signal amplifier circuit 93C amplifying the audio signal so as to have a desired volume; a speaker 96 outputting the amplified audio signal to outside; a video signal processing circuit 94B performing a predetermined image signal process such as, for example, contrast adjustment, color adjustment or brightness adjustment on the digital component signal outputted from the video signal converter circuit 92A or the MPEG decoder 92B; the image signal correction section 5 and the liquid crystal display section 1 which are described in the above embodiments; a remote control receiving section 97A receiving a remote control signal S1 from a remoter controller (not shown); a network terminal section 97B inputting outside input data D2 (an audio signal and a video signal) via an outside network (not shown) such as, for example, a wired local area network (LAN); a network I/F (interface) 97C as an interface section of the audio signal and the video signal inputted from the network terminal 97B; a CPU (Central Processing Unit) 98A controlling the operation of the whole TV 9; a flash ROM (Read On Memory) 98B as a nonvolatile memory section storing predetermined software used by the CPU 98A; an SDRAM (Synchronous Dynamic Random Access Memory) 98C as a memory section corresponding to the execution area of the CPU 98A; and an audio/video signal decoder 98D demodulating the video signal and the audio signal inputted from outside via the network terminal section 97B and the network I/F 97C, and outputting the video signal and the audio signal as a digital component signal and a digital audio signal, respectively. Moreover, the network I/F 97C, the CPU 98A, the flash ROM 98B, the SDRAM 98C and the audio/video signal decoder 98D are commonly connected by, for example, an interior bus B1 such as a PCI (Peripheral Component Interconnect) bus. The liquid crystal display device described in the above embodiments is used also in the TV 9 with such a configuration, so an image can be displayed with high contrast and high image quality by the same effects as those in the above embodiments.

It should be understood by those skilled in the art that various modifications, combinations, sub-combinations and alterations may occur depending on design requirements and other factors insofar as they are within the scope of the appended claims or the equivalents thereof.

What is claimed is:

1. A liquid crystal display device comprising:
a liquid crystal display panel including a plurality of pixels for displaying images; and
a drive means for driving the liquid crystal display panel while correcting pixel data of each pixel one after another, so that a voltage ratio between a voltage applied to one pixel and a voltage applied to its neighboring pixel is reduced.

2. The liquid crystal display device according to claim 1, wherein
the drive means includes:
a comparison circuit comparing pixel data of one pixel and pixel data of its neighboring pixel;
a correction circuit correcting pixel data one after another so that the voltage ratio is reduced, in the case where it is determined from a comparison result by the comparison circuit that the voltage ratio is larger than a predetermined threshold value; and
a drive circuit driving the liquid crystal display panel on the basis of pixel data corrected by the correction circuit.

3. The liquid crystal display device according to claim 1, wherein
the drive means corrects pixel data one after another with reference to a correction table providing a relationship between the pixel data of one pixel and its neighboring pixel and the correction amounts on the pixel data of the pixels.

4. The liquid crystal display device according to claim 1, wherein
the drive means corrects pixel data one after another by increasing a voltage applied to black-display pixels.

5. The liquid crystal display device according to claim 1, wherein
the drive means performs a PWM drive operation on the basis of the pixel data, while increasing “L (low)” level voltage of PWM pulse and decreasing “H (high)” level voltage thereof.

6. The liquid crystal display device according to claim 1, wherein
the drive means performs a PWM drive operation on the basis of the pixel data, while shifting a voltage application period in a time axis direction so that the voltage application periods of neighboring pixels overlap each other for a longer time.

7. The liquid crystal display device according to claim 1, wherein
the liquid crystal display panel includes a vertically-aligned liquid crystal molecules with a predetermined pretilt angle.

8. The liquid crystal display device according to claim 7, wherein
the drive means selectively corrects pixel data one after another on each couple of neighboring pixels arranged such that a transition of pixel display state from white to black takes place along a direction of a horizontal component or a vertical component of a vector representing a tilt direction of the vertically-aligned liquid crystal molecules under application of voltage to pixels.

9. The liquid crystal display device according to claim 1, wherein
the liquid crystal display panel is of reflective type, and
the drive means corrects pixel data one after another on the basis of the time integration value of the reflectivity of pixels over a plurality of frame periods.

10. The liquid crystal display device according to claim 1, wherein
the drive means corrects pixel data one after another in a mode of field inversion drive or frame inversion drive.

11. The liquid crystal display device according to claim 1, wherein
the liquid crystal display panel is configured of a reflective type to include:
a pixel electrode substrate including a plurality of pixel electrodes of a reflective type;
an opposed substrate including an opposed electrode which faces the pixel electrodes; and
a liquid crystal injected between the pixel electrode substrate and the opposed substrate.

12. A liquid crystal display comprising a liquid crystal display device, and displaying an image through the use of light modulated by the liquid crystal display device,
wherein the liquid crystal display device includes:
a liquid crystal display panel including a plurality of pixels for displaying images; and
a drive means for driving the liquid crystal display panel while correcting pixel data of each pixel one after another, so that a voltage ratio between a voltage applied to one pixel and a voltage applied to its neighboring pixel is reduced.

13. The liquid crystal display according to claim 12 configured as a liquid crystal projector, comprising:
a light source; and
a projection means for projecting light to a screen, the light being emitted from the light source and modulated by the liquid crystal display device.

14. A method of driving a liquid crystal display device including a liquid crystal display panel with a plurality of pixels for displaying images, the method comprising the steps of:
comparing pixel data of one pixel and pixel data of its neighboring pixel;
correcting pixel data one after another so that the voltage ratio between a voltage applied to the pixel and a voltage applied to the neighboring pixel is reduced, in the case where it is determined from a comparison result that the voltage ratio is larger than a predetermined threshold value; and
driving the liquid crystal display panel on the basis of pixel data corrected.

15. A liquid crystal display device comprising:
a liquid crystal display panel including a plurality of pixels for displaying images; and
a drive section driving the liquid crystal display panel while correcting pixel data of each pixel one after another, so that a voltage ratio between a voltage applied to one pixel and a voltage applied to its neighboring pixel is reduced.

16. A liquid crystal display comprising a liquid crystal display device, and displaying an image through the use of light modulated by the liquid crystal display device,
wherein the liquid crystal display device includes:
a liquid crystal display panel including a plurality of pixels for displaying images; and
a drive section driving the liquid crystal display panel while correcting pixel data of each pixel one after another, so that a voltage ratio between a voltage applied to one pixel and a voltage applied to its neighboring pixel is reduced.
